(19) United States
(12) Patent Application Publication
(10) Pub. No.: US 2008/0273339 A1
(43) Pub. Date: Nov. 6, 2008

(54) Structure of a light shade of a light emitting component

(76) Inventor: Hua-Hsin Tsai, Linnei Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/797,109

(22) Filed: May 1, 2007

(51) Int. Cl. F21V 1/12

(52) U.S. Cl. 362/361

(57) ABSTRACT

A light shade of a light emitting component includes a body, which is solid and pervious-to-light body, and made of glass/quartz, and has a straight bottom surface, and a spherical upper surface; the body of the light shade has undergone a surface-dimming process to have a lumpy surface, which has depressions and lumps all over, so as to substantially improve in its refracting capability; thus, light-emitting efficiency and brightness of the light emitting component are obviously enhanced.

### BACKGROUND OF THE INVENTION

1. Field of the Invention

The present invention relates to a light shade of a light emitting component, more particularly one, which has undergone a dimming process to have depressions and lumps on its surface so as to significantly improve in its refracting capability, thus helping to enhance light-emitting efficiency and brightness of the light emitting component.

2. Brief Description of the Prior Art

A relatively high proportion of fires resulted from carelessness and mistakes in using Kerosene lamps in early days when Kerosene lamps were the major lighting devices, and bulbs weren't available. Bulbs have been used as the major lighting devices instead of early kerosene lamps for more than one hundred years, which are safer to use than kerosene lamps. However, bulbs have several drawbacks, e.g. having long reaction time and short service life, consuming too much power, and getting hot rapidly.

Because light emitting diodes (LED) have many advantages over conventional bulbs, e.g. consuming much less power, and having longer service life, better durability, higher resistance to shock, smaller size, and much shorter reaction time, they are gradually taking the place of bulbs as the light-emitting devices of various lamps such as traffic lights, flashlights, ornamental lamps, and taillights, indicators, and brake lights of cars. In addition, light emitting diodes won't produce heat when emitting light.

Referring to FIG. 1, a currently existing light emitting diode 1 includes a circuit base board 11, a light emitting chip 12 fitted on the circuit base board 11, a reflecting frame part 13, a light shade 14, and an electrode 15 connected to the light emitting chip 12. The reflecting frame part 13 is made of opaque plastic materials, and fitted on the circuit base board 11 to enclose the light emitting chip 12 so as to prevent light emitted from the light emitting chip 12 to scatter. The light shade 14 is disposed on top of the reflecting frame part 13, and made of a mixture of fluorescent powder and epoxy resin, which has been already shaped into a cake, which is next heated and molded with a mold so as to become the light shade.

However, the above light emitting diode has the following drawbacks:

1. The light shade is made of a mixture of fluorescent powder and epoxy resin; it is highly possible for the fluorescent powder not to be evenly distributed over the light shade. Light emitted from the light emitting diode can't evenly spread in a satisfactory manner.

2. Because the light shade is made of a mixture of fluorescent powder and epoxy resin, it is prone to yellow and age to cause weakening of light emitted from the light emitting diode. Consequently, light emitting efficiency of the light emitting diode is reduced.

### SUMMARY OF THE INVENTION

It is a main object of the present invention to provide an improvement on a light shade structure of a light emitting component to overcome the above problems.

A light shade according to an embodiment of the present invention includes a solid and pervious-to-light body, which can be made of glass or quartz, and which has a straight bottom surface, and a spherical upper surface. In manufacturing, the body of the light shade undergoes a surface-dimming process to have a lumpy surface so as to substantially improve in its refracting capability, which has depressions and lumps all over, thus enhancing light-emitting efficiency and brightness of the light emitting component.

The light shade further has a pervious-to-light fluorescent layer to change color of light emitted from the light emitting component, which can be provided on either of the straight bottom surface and the spherical upper surface of the light shade body, and which can be provided by means of applying fluorescent powder to the light shade body or by means of sticking pervious-to-light band-shaped members to the body, which contain fluorescent powder. A recess can be formed on the straight upper surface of the light shade body for receiving the pervious-to-light fluorescent layer.

### BRIEF DESCRIPTION OF THE DRAWINGS

The present invention will be better understood by referring to the accompanying drawings, wherein:

FIG. 1 is a sectional view of the prior art,

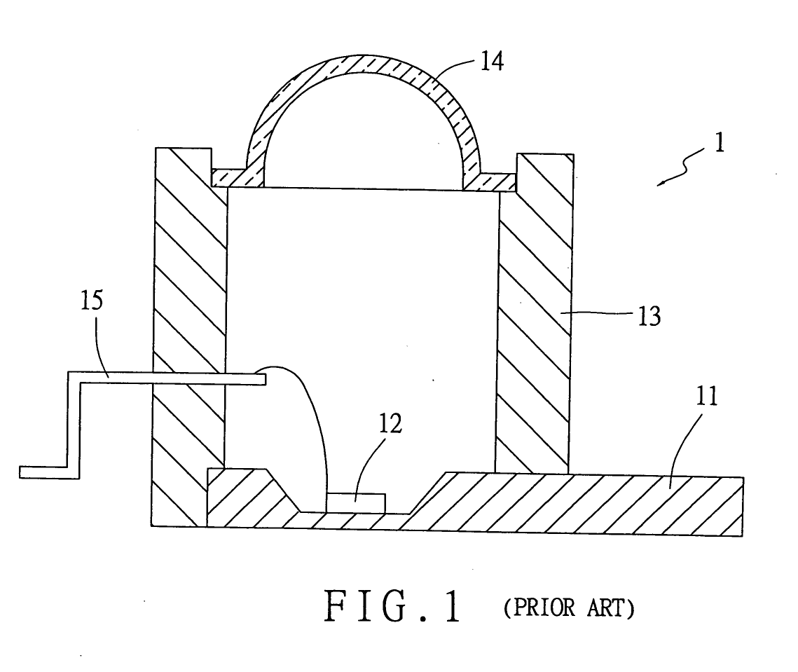

FIG. 2 is a sectional view of a first preferred embodiment of a light shade of the present invention,

FIG. 3 is a sectional view of the first preferred embodiment fitted to the light emitting component,

FIG. 4 is a sectional view of a second preferred embodiment,

FIG. 5 is a sectional view of a third preferred embodiment, and

FIG. 6 is a sectional view of a fourth preferred embodiment.

### DETAILED DESCRIPTION OF THE PREFERRED EMBODIMENTS

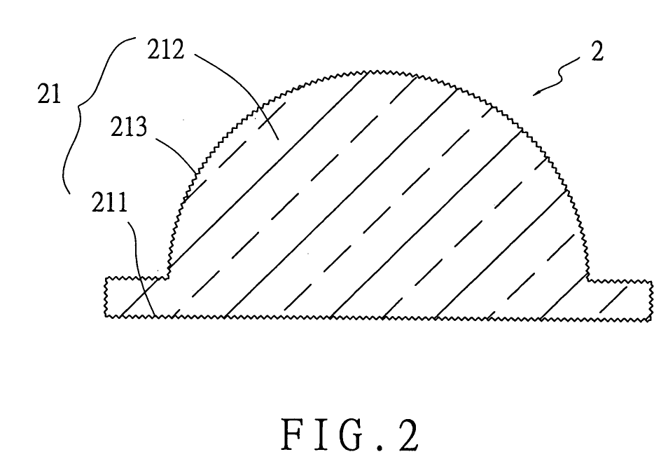

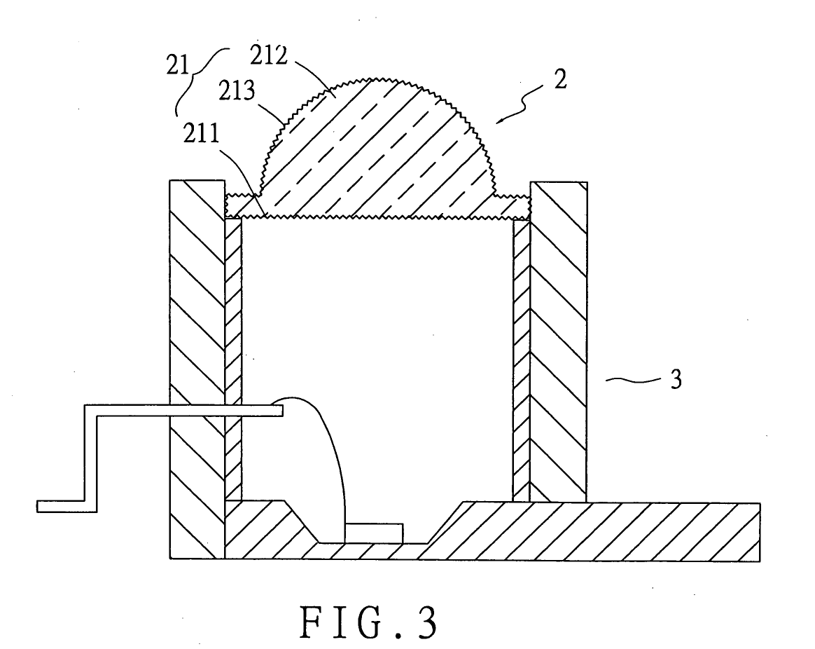

Shown in FIGS. 2 and 3 is a first preferred embodiment of an improvement on a light shade 2 of a light emitting component of the present invention, which is disposed on a body 3 of the light emitting component.

The light shade 2 includes a body 21, which is solid and pervious to light, and made of a material such as glass and quartz, and which has a straight bottom surface 211, and a spherical upper surface 212. In manufacturing, the body 21 of the light shade 2 is soaked in and etched with hydrofluoric acid so as to have depressions and lumps on both the straight bottom surface 211 and the spherical upper surface 212 thereof; in other words, the light shade body 21 has a lumpy surface 213.

Therefore, the light shade 2 will refract light emitted from the body 3 of the light emitting component more effectively owing to the lumpy surface 213 of the body 21 thereof.

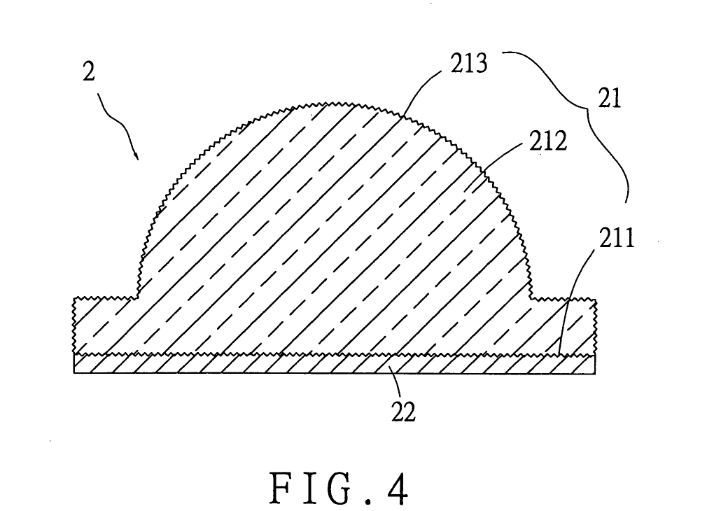

Shown in FIG. 4 is a second preferred embodiment of a light shade 2 of a light emitting component of the present invention, which has a pervious-to-light fluorescent layer 22 on a straight bottom surface 211 of a body 21 thereof such that light emitted from the body 3 of the light emitting component will be caused to change color by means of the pervious-to-light fluorescent layer 22; the pervious-to-light fluorescent layer 22 can be provided by means of evenly applying fluorescent powder to the straight bottom surface 211 of the body 21 of the light shade 2 or sticking pervious-to-light band-shaped members, which contain fluorescent powder, to the straight bottom surface 211. Thus, light emitted from the body 3 of the light emitting component will change color according to a color of the pervious-to-light fluorescent layer 22.

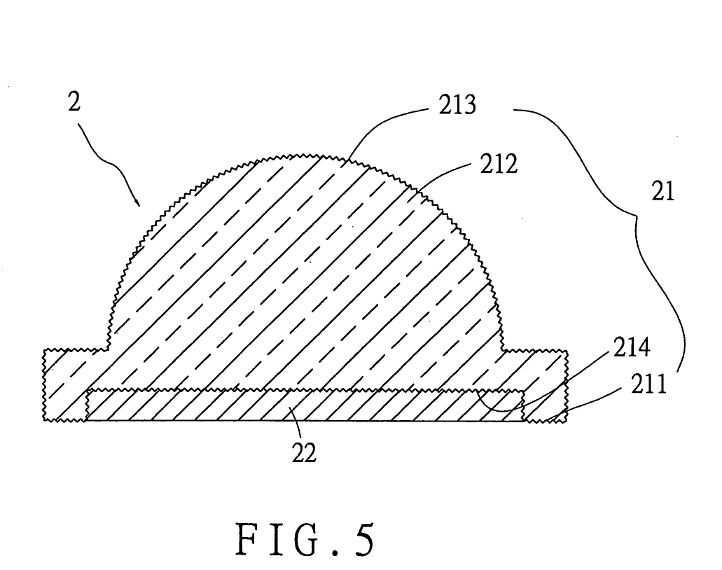

Shown in FIG. 5 is a third preferred embodiment of a light shade 2 of a light emitting component of the present invention, which includes a body 21, and a pervious-to-light fluorescent layer 22; the body 21 has a straight bottom surface 211 having a recess 214 thereon, and the pervious-to-light fluorescent layer 22 is received in the recess 214 to change the color of light emitted from the body 3 of the light emitting component.

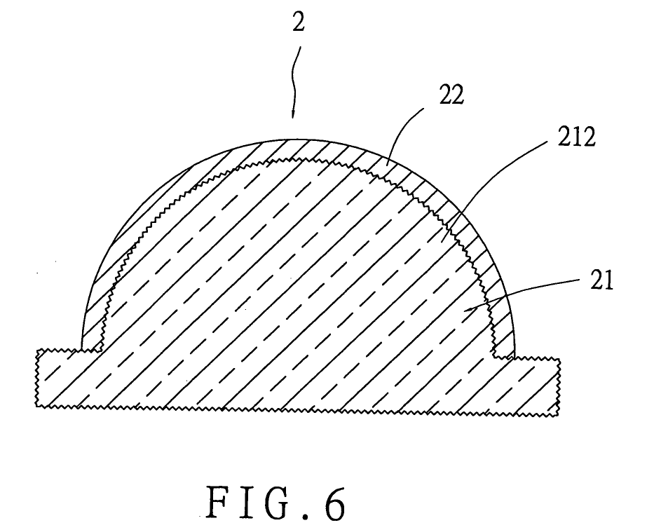

Shown in FIG. 6 is a fourth preferred embodiment of a light shade 2 of a light emitting component of the present invention, which includes a body 21, and a pervious-to-light fluorescent layer 22; the body 21 has a spherical upper surface 212, and the pervious-to-light fluorescent layer 22 is provided on the spherical upper surface 212 of the light shade body 21 for changing the color of light emitted from the body 3 of the light emitting component.

From the above description, it can be seen that the present invention has the following advantages:

1. The body of the light shade is made of either of glass and quartz, and is etched so as to have depressions and lumps over its surface; owing to the depressions and lumps on the surface, the light shade can refract light more effectively, thus helping to increase light-emitting efficiency and brightness of the light emitting component.

2. The light shade is made of glass/quartz therefore it doesn't have the disadvantage of the above equivalent used on the prior light emitting diode, which is made of epoxy resin, and is prone to yellow and age to weaken light emitted from the prior light emitting diode. Consequently, light emitted from the light emitting component of the present invention will evenly spread.

What is claimed is:

1. An improvement on a structure of a light shade of a light emitting component, comprising
a solid and pervious-to-light body, the body of the light shade having a straight bottom surface, and a spherical upper surface; the body of the light shade being processed so as to have a lumpy surface having plural depressions and lumps.

2. The improvement on a structure of a light shade of a light emitting component as recited in claim 1, wherein the body of the light shade is made of glass.

3. The improvement on a structure of a light shade of a light emitting component as recited in claim 1, wherein the body of the light shade is made of quartz.

4. The improvement on a structure of a light shade of a light emitting component as recited in claim 1, wherein a pervious-to-light fluorescent layer exists on the straight bottom surface of the body.

5. The improvement on a structure of a light shade of a light emitting component as recited in claim 4, wherein the pervious-to-light fluorescent layer is formed by means of applying fluorescent powder to the straight bottom surface of the body.

6. The improvement on a structure of a light shade of a light emitting component as recited in claim 4, wherein the pervious-to-light fluorescent layer includes a plurality of pervious-to-light band-shaped members, which contain fluorescent powder.

7. The improvement on a structure of a light shade of a light emitting component as recited in claim 1, wherein the straight bottom surface of the body has a recess thereon, and a pervious-to-light fluorescent layer exists in the recess.

8. The improvement on a structure of a light shade of a light emitting component as recited in claim 7, wherein the pervious-to-light fluorescent layer is formed by means of applying fluorescent powder to the straight bottom surface of the body.

9. The improvement on a structure of a light shade of a light emitting component as recited in claim 7, wherein the pervious-to-light fluorescent layer includes a plurality of pervious-to-light band-shaped members, which contain fluorescent powder.

10. The improvement on a structure of a light shade of a light emitting component as recited in claim 1, wherein a pervious-to-light fluorescent layer exists on the spherical upper surface of the body.

11. The improvement on a structure of a light shade of a light emitting component as recited in claim 10, wherein the pervious-to-light fluorescent layer is formed by means of applying fluorescent powder to the spherical upper surface of the body.

12. The improvement on a structure of a light shade of a light emitting component as recited in claim 10, wherein the pervious-to-light fluorescent layer includes a plurality of pervious-to-light band-shaped members, which contain fluorescent powder.
